(19) United States
(12) Patent Application Publication
(10) Pub. No.: US 2024/0394628 A1
(43) Pub. Date: Nov. 28, 2024

(54) TASK PRIORITIZATION BASED UPON DEVICE SELECTION

(71) Applicant: Lenovo (United States) Inc., Morrisville, NC (US)

(72) Inventors: Russell S. VanBlon, Raleigh, NC (US); Robert J. Kapinos, Durham, NC (US); Robert James Norton, JR., Raleigh, NC (US); Scott Wentao Li, Cary, NC (US)

(21) Appl. No.: 18/324,490

(22) Filed: May 26, 2023

(51) Int. Cl. G06Q 10/0631

(52) U.S. Cl. CPC G06Q 10/06316

(57) ABSTRACT

One embodiment provides a method, the method including: identifying, utilizing a task priority system, a plurality of tasks to be performed by a user utilizing an information handling device; determining, based on an analysis of attributes of each of the plurality of tasks and utilizing the task priority system, a priority of the plurality of tasks at least based in part on the information handling device being utilized by the user; and providing, utilizing the task priority system, an output of the priority of the plurality of tasks to the user. Other aspects are claimed and described.

### BACKGROUND

An efficient performance of a task at a device commonly requires a device that can fulfill the requirements of the task. As processing power grows in all devices, the ability to perform a plurality of tasks at a plurality of different devices has become more common. Additionally, users typically have access to multiple devices that can be utilized in the performance of tasks. Thus, tasks that used to require a specific device may now be completed at one of a variety of devices. However, task completion using one device may be less efficient than another device due to differences in characteristics or attributes of the different devices that a user may access and utilize.

### BRIEF SUMMARY

In summary, one aspect provides a method, the method including: identifying, utilizing a task priority system, a plurality of tasks to be performed by a user utilizing an information handling device; determining, based on an analysis of attributes of each of the plurality of tasks and utilizing the task priority system, a priority of the plurality of tasks at least based in part on the information handling device being utilized by the user; and providing, utilizing the task priority system, an output of the priority of the plurality of tasks to the user.

Another aspect provides an information handling device, the information handling device including: a processor; a memory device that stores instructions that when executed by the processor, causes the information handling device to: identify, utilizing a task priority system, a plurality of task to be performed by a user utilizing an information handling device; determine, based on an analysis of attributes of each of the plurality of tasks and utilizing the task priority system, a priority of the plurality of tasks at least based in part on the information handling device being utilized by the user; and provide, utilizing the task priority system, an output of the priority of the plurality of tasks of the user.

A further aspect provides a product, the product including: a computer-readable storage device that stores executable code that, when executed by a processor, causes the product to: identify, utilizing a task priority system, a plurality of tasks to be performed by a user utilizing an information handling device; determine, based on an analysis of attributes of each of the plurality of tasks and utilizing the task priority system, a priority of the plurality of tasks at least based in part on the information handling device being utilized by the user; and provide, utilizing the task priority system, an output of the priority of the plurality of tasks to the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for prioritizing a plurality of tasks based upon attributes of each of the tasks and an information handling device the user is utilizing to perform the tasks.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When a user is attempting to perform tasks using an information handling device (e.g., laptop computer, tablet, personal computer, smart phone, smart watch, entertainment systems, etc.), the efficient and effective performance of the tasks is dependent on characteristics of the device the user it utilizing. For example, if the task to be performed requires capturing an image of an object or document, then the device needs to have the ability to capture an image. While some device can communicate with other devices that may have an image capture device, the use of multiple devices to perform the task results in the task taking longer to complete. As another example, devices having small form factors (e.g., mobile phones, tablets, smart watches, etc.) may reduce the efficiency of performance of a task that requires the digestion and/or manipulation of large amounts of information.

Conventionally, it is up to the user who is performing the tasks to determine which device is best suited for performance of the task. Today, there are a plurality of devices that can be utilized to perform a single task. For example, users may use any one of smart phones, laptop computer, tablets, smart watches, and/or the like, to access and respond to email communications. Since multiple different devices could be used to perform one or more tasks, it is common practice for a user to attempt to use a single device, or a minimal number of different devices, to perform a plurality of tasks. However, the efficiency, effectiveness, and/or quality of the task may suffer when an incorrect, or unideal, device is utilized to perform a task. The use of such unideal devices may then add additional time to completing a task as compared to using an ideal or appropriate device. What is needed is a system that can analyze tasks that need to be performed by a user and prioritize the tasks based at least in part on the device that the user is currently utilizing the perform the tasks.

Accordingly, the described system and method describes a technique for providing an output of a priority of a plurality of tasks to a user by use of a task priority system. The system, in communication with and/or employing a task priority system, may identify a plurality of tasks requested to be performed by a user utilizing an information handling device. This plurality of tasks may be received and ordered in a task queue, and may originally be sorted based upon a predetermined attribute, for example, sorted based upon a timestamp, an item type, and/or the like. The task priority system may then determine, based upon an analysis of an attribute associated with each task received, a priority, or an order for the tasks to be completed based at least in part on the device the user is utilizing for performing the tasks.

After analyzing attributes associated with each task, the task priority system may prioritize tasks that can be completed on the information handling device of a user. Additionally, the system may identify an urgency of the tasks to be completed. If a task is urgent, the system may prioritize the task for completion even if the device the user is currently utilizing is not the ideal device for performing the task. The system may utilize the task priority system of the information handling device to provide an output of the priority of the plurality of tasks to the user. This priority information may then instruct a user and/or an application of the information handling device to complete a task. The system may also identify the ideal device for performing a task and provide an output of this identification to the user, thereby giving the user the option to switch to a more ideal device to perform the task.

Such a system establishes a priority order for a plurality of tasks responsible to a user. The system's ability to analyze attributes of a task received, and then determine whether the information handling device in use either can be used to complete the task or whether the device is an ideal device for performing a task, provides a user with an order to most efficiently complete tasks assigned. After completion of the tasks at the information handling device of the user, or in response to transitioning to a new device with different device attributes, a priority of the plurality of tasks may be dynamically adjusted. Thus, such a system provides a method that promotes efficiency, effectiveness, and quality in the completion of tasks, and may further assist a user in determining the most ideal device to use to perform a task.

The illustrated example embodiments will be best understood by reference to the figures. The following description is intended only by way of example, and simply illustrates certain example embodiments.

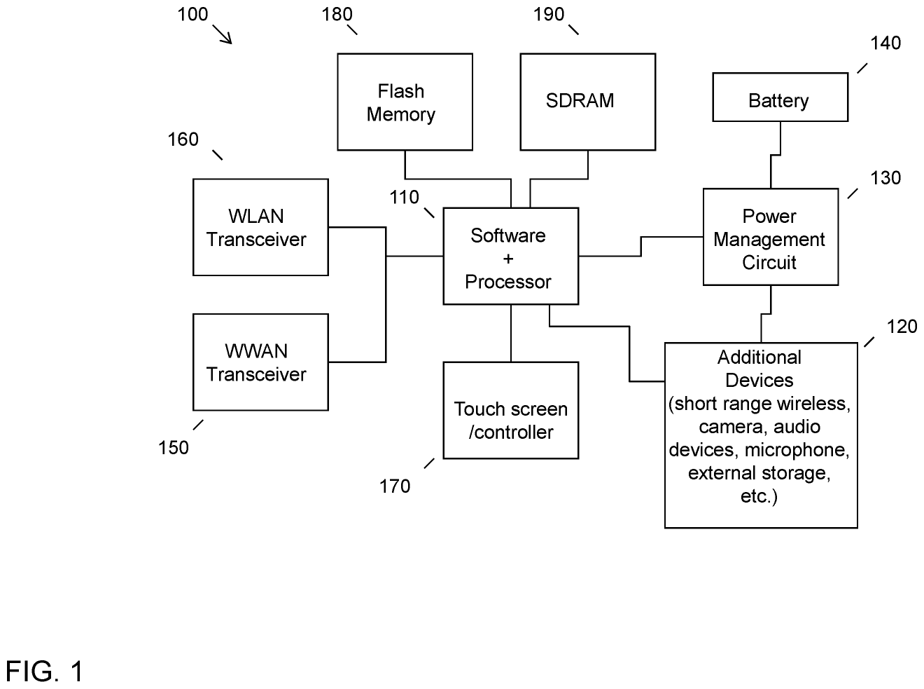

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

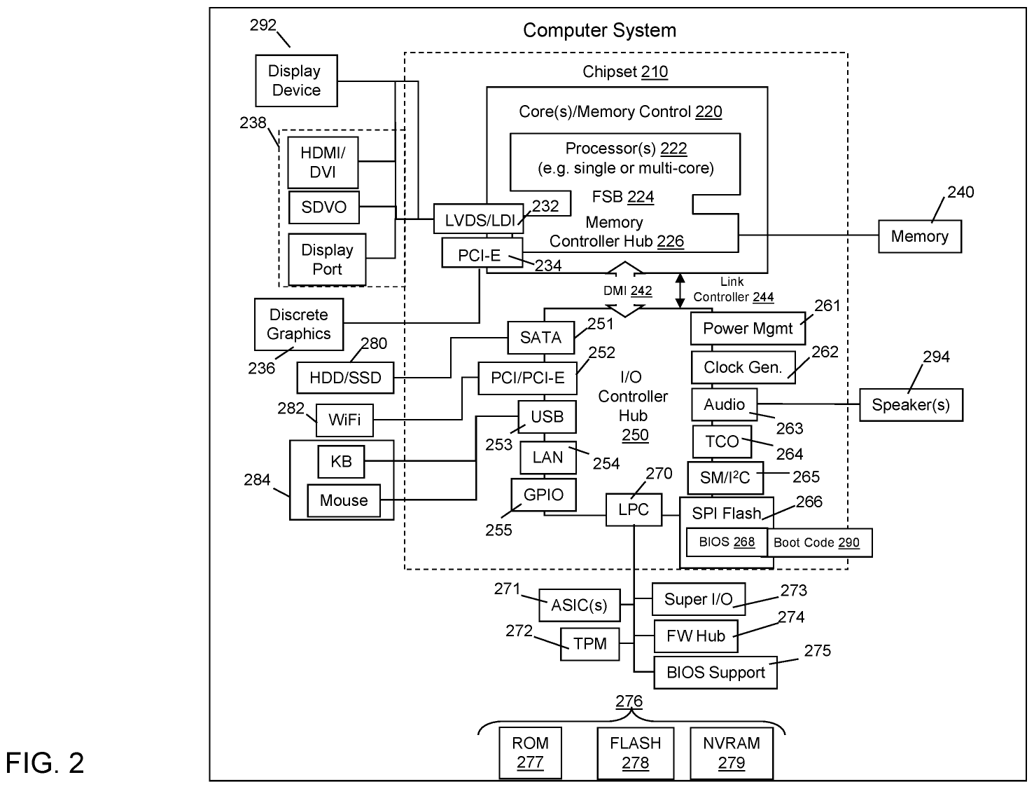

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in a system that analyzes attributes for a plurality of received tasks to determine a priority of the plurality of tasks at least based in part on the device the user is utilizing, and thereafter, provides an output of the priority of the plurality of tasks to a user. For example, the circuitry outlined in FIG. 1 may be implemented in a tablet or smart phone embodiment, whereas the circuitry outlined in FIG. 2 may be implemented in a personal computer embodiment.

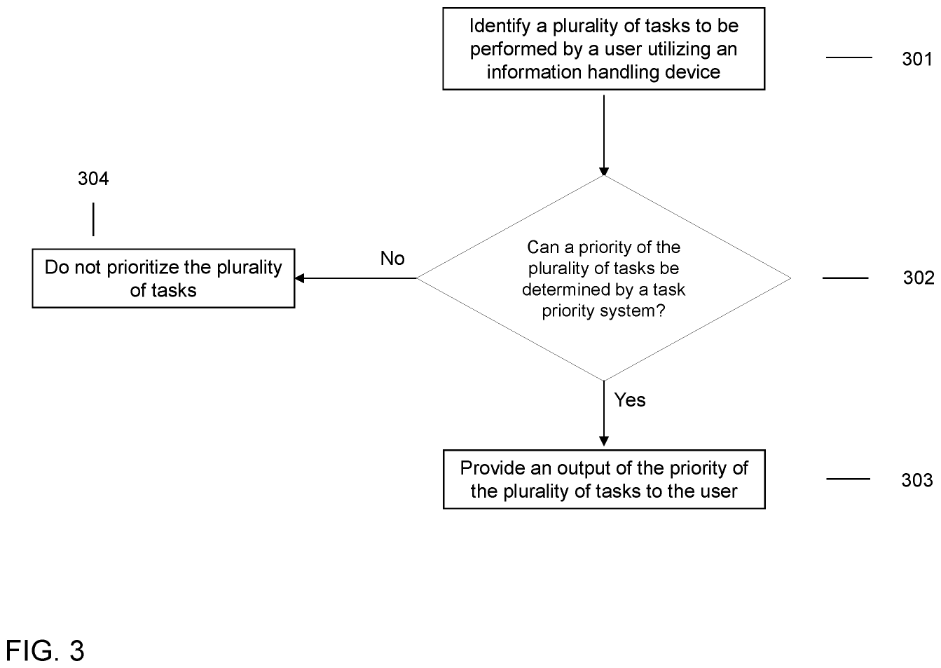

FIG. 3 illustrates an example method for prioritizing a plurality of tasks based upon attributes of each of the tasks and an information handling device the user is utilizing to perform the tasks. The method may be implemented on a system which includes a processor, memory device, output devices (e.g., display device, etc.), input devices (e.g., keyboard, touch screen, mouse, microphones, sensors, biometric scanners, etc.), and/or other components, for example, those discussed in connection with FIG. 1 and/or FIG. 2. While the system may include known hardware and software components and/or hardware and software components developed in the future, the system itself is specifically programmed to perform the functions as described herein to prioritize, using a task priority system, a plurality of tasks based upon analyzing attributes of each task and provide an output of the prioritization.

The task priority system may run in the background of an information handling device and may be activated when the device is activated. Additionally, or alternatively, the system may be activated when an application associated with a task is activated, detected, or otherwise opened. The system may also activate the system upon receiving a task at an information handling device of the user. In this case, the task priority system may not be activated until at least one task has been received at an information handling device associated with a user.

Once the task priority system is activated on a device, the task priority system may be utilized throughout the process of identifying a plurality of tasks to be performed by a user utilizing an information handling device, determining a priority of the plurality of tasks at least based in part on the information handling device being utilized by the user, and providing an output of the priority of the plurality of tasks to the user. Continued use of the task priority system in identifying a plurality of tasks to be performed, determining a priority of the plurality of tasks based on an analysis of attributes of each task, and identifying which devices are best suited or ideal devices for performing a task will train the system in producing an accurate output of the priority of the plurality of tasks to the user. The system may also become unique to a user and determine device preferences of the user with respect to the performance of tasks and utilize this information to prioritize tasks. To perform the steps present in the task priority system and in order to accurately determine a priority of the plurality of tasks at least based in part on the information handling device being utilized by the user, the task priority system may utilize a neural network, machine-learning model, and/or other learning algorithm, collectively referred to as a machine-learning model for ease of readability. The machine-learning model can be trained utilizing previously supplied tasks, previously identified ideal devices, and previously produced outputs of a priority order for a plurality of tasks. In other words, the machine-learning model is given access to previous outputs related to a priority for a plurality of tasks and previously analyzed attributes associated with both a task and an information handling device utilized to complete a task. These established outputs of priority, analysis of attributes, identification of ideal devices, and/or the like, are referred to as a training dataset.

Using the training dataset, which may change over time, the machine-learning model learns nuances between tasks needing to be performed by a user and the most efficient or ideal information handling device to utilize when completing a task. This results in more accurately providing an output of the priority of the plurality of tasks to the user. For example, the machine-learning model can learn what is required to complete a task and/or what device can complete a specific task most efficiently. Additionally, the model can identify preferences of the user with respect to devices for task completion or performance. As information is determined with respect to task priority, task attributes, and ideal devices, the machine-learning model can learn additional nuances and become more accurate and refined over time. Thus, while there is an initial training dataset that is used to initially train the machine-learning model, the machine-learning model is learning over time based upon new information received by the machine-learning model, thereby evolving to become more accurate. It should be noted that the machine-learning model can automatically ingest the feedback or new information as it becomes available in order to become more refined and more accurate.

At 301, the task priority system identifies a plurality of tasks to be performed by a user utilizing an information handling device. Identifying a plurality of tasks may include receiving an indication (e.g., an email, a calendar reminder, a text message, an instant message, a task reminder, etc.) associated with a requirement for completing a task and/or accessing a task assignment system (e.g., internal business dockets, user profile, etc.). The indication may describe or otherwise identify one or more tasks needing to be completed by a user. The task priority system may collect the plurality of tasks identified, at 301, in a task queue. The task queue is a data storage location present within the task priority system that may store and identify an order of the identified plurality of tasks to be performed by a user. The order of tasks within the task queue may change dynamically.

Upon identifying the plurality of tasks to be performed by the user, at 301, the task priority system may analyze attributes of each of the plurality of tasks to determine a priority of the plurality of tasks at 302. Determining a priority of the plurality of tasks will establish an order of performance and/or completion of the plurality of tasks based upon an efficiency and urgency of completion of an identified task. An analysis of the attributes of each of the plurality of tasks may identify an urgency of each of the plurality of tasks. In determining whether a priority of tasks can be determined, at 302, the task priority system may initially account for any urgency indications associated with a task. An urgency indication may include, for example, a time frame associated with completion of a task, a deadline for completion of a task, a requestor of the task (e.g., certain requestors may be cause a task to be identified as urgent, a number of requestors included on the task, etc.), a topic or keyword associated with the task, user defined urgency indicators, and/or the like. In the event of more than one task being identified as urgent, the system may rank urgent tasks, and based upon the determined rank, a priority of a task over at least one other task. Thus, a task with a determined higher urgency may be prioritized over at least one other task to be performed by the user with a lower urgency.

An urgency of the task to be completed may be based upon historical data associated with a response time of the user with respect to a task having a similarity to each of the plurality of tasks. Thus, a task priority system may access a user profile identifying a response time of a user with respect to a specific task. A user profile may include user information identifying a response time and/or a completion rate for a type of task based upon the content of the task. This information may be manually provided by the user, or may be identified by the system by mining historical information for tasks, task attributes, task start times, task completion times, and/or the like.

When the task priority system is performing an analysis of the attributes of each task, the system may determine a type for each task based upon the content present in the task, for example, a phone call, a required response, a request to access secure data, an expected product denoting completion of the task, and/or the like. The system may identify and determine a type of task from the content of the task to be performed by a user. Thus, the system may parse the content of the task or other characteristics or information of the task to identify and classify the content of the task. Such parsing and analyzing may be performed using one or more techniques, for example, optical character recognition, image analysis, audio analysis, natural language processing, information extraction, semantic analysis, syntactic analysis, parts-of-speech analysis, classification, and/or the like. This analysis may also be facilitated utilizing one or more machine-learning models, as previously described. Other attributes of the task that may be identified include a requested response time, a requestor, a due date, applications needed to perform the task, components needed to perform the task, other users needed to perform the task, and/or the like.

The priority of the plurality of tasks is at least based in part on the information handling device being utilized by the user. In other words, the priority of a task may include prioritizing tasks that may be completed on the current device in use. For example, the task priority system may determine that a user is on a smartphone, and then may prioritize tasks that may efficiently be completed on a smartphone (e.g., response to emails, phone calls, simple research, etc.). Determining a priority of tasks based upon the current device in use may include determining which tasks may be completed on the device.

This determination may be based upon components of the device, applications accessible to the device, and requirements or attributes of the task to be completed. Since the attributes of the task identify different requirements for performance of the task, these attributes can be compared to components and/or applications accessible by the current device in use to determine if the device can support performance of the task. Tasks requiring components and/or applications not accessible by the device will be prioritized lower than tasks requiring components and/or applications accessible by the device. For example, a task requiring an image capturing device may be prioritized higher when the device does include an image capturing device as compared to when the device does not include an image capturing device. The system may also note which components and/or applications are located or accessible locally to the device and which components and/or applications are located or accessible remotely from the device. Components and/or applications located or accessible remotely from the device, may cause the system to prioritize a task requiring these components and/or applications to be prioritized lower than tasks requiring components and/or applications that are located or accessible locally to the device.

When prioritizing tasks, the system may take into account secondary information, for example, information about the user, information about other users regarding devices utilized for tasks and times needed to perform the tasks, and/or the like. This information may include information within a user profile, which may include, but is not limited to, user preference, user response or performance times, information about current and expected locations of a user, information regarding devices accessible to a user at particular times or locations, schedules of the user, and/or the like. The user profile may include response or performance times corresponding to each task type with respect to different information handling devices utilized or accessible to the user; user preferences regarding devices preferred for performance of a task; machine-learning model information related to the user, tasks, and devices; and/or the like. The system may then prioritize the tasks based upon the information contained within the user profile. For example, if the user is using a device that the user prefers to perform one of the tasks, the system may prioritize that task higher than a task the user prefers to perform using a different device. As another example, if the user is using a device that has historically been used and results in a quicker performance or response time than another device, the task may be prioritized higher than a task that has historically been used and results in a slower performance or response time than another device.

The system may also utilize information regarding the user to determine a priority of a task. For example, if the system knows that the user will be utilizing another device that is more suited for a task within a particular timeframe, the system may prioritize that task lower than another task knowing that the task will be prioritized higher once the user accesses the more suitable device. As previously mentioned, determining the user will be utilizing a different device may be based upon the schedule of the user, historical location and time information of a user, the user profile, and/or the like. As another example, if the system knows that the user has access to other devices within a location, the system may prioritize tasks more suitable to those devices lower than tasks more suitable for the current device. As another example, if the system knows that the user will be changing device or locations at a particular time, the system may prioritize tasks for the current device based upon an estimated performance time for the tasks, where tasks able to be completed before the user changes devices or locations will be prioritized over tasks unable to be completed in the time frame.

Thus, when determining a priority of the plurality of tasks, a priority of a task of the plurality of tasks for which the information handling device is suitable for performing the tasks is higher than a priority of other tasks of the plurality of tasks that are more suitable for another information handling device. In other words, the system will prioritize tasks that are suited, or can be completed, at the information handling device in use over tasks that are suited for another information handling device. The priority can be further refined based upon the user preferences. For example, even if a device is suitable for a task, the task may have a lower priority than another task for which the device is suitable based upon a preference of the user to use the device for the task.

In response to identifying the information handling device in use is unsuitable for performing a task of the plurality of tasks or that another device is more suitable for performance of the task, the system may recommend another information handling device to be used to perform the task. When recommending another device, the system may specifically identify the device that should be utilized, for example, via a device identifier, device nickname, device location, and/or other identifying information that the user could utilize to determine which device is being recommended. The recommendation may include providing a pop-up window, placing a label next to the task, grouping tasks by recommended devices, and/or any other technique to designate a device for a particular task. In the case that more suitable device is available for a task having a high urgency, the recommendation may be more prominent so that the user can be made aware of the device recommendation as quickly as possible.

When the user accesses a different information handling device, the system may reprioritize the tasks based upon that new device that is being utilized. Thus, the prioritization of the tasks can be dynamically modified based upon the device that the user it utilized. Additionally, the prioritization of the tasks can be dynamically modified if a new task comes in that has a higher priority or urgency than currently prioritized tasks. It should be noted that for all prioritization, the urgency of the task may take precedence within the prioritization. For example, an urgency may override a prioritization based upon device suitable, user preference, and/or the like. However, a user may set what factors (e.g., urgency, device attributes, user schedule, user preference, etc.) take precedence over other factors.

When it is determined that a priority of the plurality of tasks cannot be determined, the system may not prioritize tasks at 304. Failure to prioritize the tasks will result in a user performing a task in an order not established on efficiency, and potentially at a device with a poor performance time. The inability to prioritize the tasks may occur if the system cannot access particular attributes, if the user denies access to the task priority system, if the tasks all result in the same priority, and/or the like.

However, when it is determined that the task priority system can determine a priority of the plurality of tasks, at 302, the system may then provide an output of the priority of the plurality of tasks to the user, at 303. When providing an output of the priority of the plurality of tasks to the user, the task priority system may provide a dynamically adjusted task queue listing the plurality of tasks in a priority based upon the determination of the priority. Providing the output may include, for example, providing a notification from the task priority system to the user identifying each of the plurality of tasks to be performed by the user and an order of performance, providing a notification from the task priority system to the user identifying the specific task(s) from the plurality of tasks that may be performed on the device being utilized by the user, providing a notification from the task priority system to the user recommending a different information handling device to perform an outlined task(s) at the new device, and/or the like. Providing such output to the user may instruct how the user may most efficiently complete all tasks required to be performed by the user.

The system may also provide other information along with the priority information. For example, the system may provide an estimated performance time for one or more of the tasks. This estimated performance time may be based upon the historical information contained within the user profile. The estimated performance time may be useful to the user in determining which task to perform in the case of same priority tasks. It may also be useful if the user knows that they will only be at the device for a particular length of time.

The following paragraphs include multiple example situations for the described system. These examples are non-limiting examples, and are meant to provide additional clarity regarding the system and method disclosed herein.

In an example, a task priority system may determine that an employee has been talking on a smartphone for an extended period of time. The user may be assigned a plurality of tasks to be performed, and the presence of a smartphone is known to the task priority system. Thus, the system may prioritize tasks that can be efficiently completed on a smartphone after completion of the phone call. Such tasks may include, but are not limited to, responding to and/or composing emails, responding to and/or composing text messages, contact research, simple searches, and/or the like.

In an example, a task priority system may determine that an employee is working on a multi-monitor desktop. The system may also access a user profile associated with the employee that includes schedule information of the employee. It is determined, by the task priority system, that the user will be moving from the multi-monitor desktop device to travel to an on-site location based upon the schedule of the employee. Knowing the employee will be transitioning from the multi-monitor desktop, may establish a priority for tasks that may require and/or are preferred by the user to be performed at such a device. Thus, the task priority system may prioritize one or more tasks to be completed at the multi-monitor desktop device prior to a user transitioning devices and traveling to a site. Such tasks that may be prioritized include, but are not limited to, emails flagged as important, emails with attachments and/or a large amount of content, tasks that require higher processing speeds, tasks that require an application present on the multi-monitor desktop device, and/or the like.

In an example, a task priority system may determine that an employee is utilizing a tablet and thereafter receives a task that requires accessing secure data. The system may determine that the tablet device does not contain a required VPN application needed in order to authenticate and then access the secure information. A task priority system may then label this task with a lower priority than other tasks at the current device because the user cannot access the secure information. However, upon transitioning to a different device that does fulfill the requirement of the VPN application, the task priority system may dynamically adjust the task priority from a lower priority to a higher priority because of the ability to perform the task at the new device.

The various embodiments herein thus describe a technical improvement over conventional methods for determining a priority of a task from a plurality of tasks to be performed by a user. A task priority system may identify a plurality of tasks assigned to be performed by a user at an information handling device, and subsequent to determining a priority of the plurality of tasks at least based in part of the information handling device being utilized by the user and an analysis of attributes for each tasks, the system may provide an output of the priority of the plurality of tasks to the user. This supplying of an output to the user provides a dynamically adjusted task completion list based upon an efficiency rate of completion for the user. Thus, the system provides improvements over traditional prioritization methods that require a user to manually determine an ideal device to perform a task and further promotes a completion of a plurality of tasks in the most efficient manner.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, utilizing a task priority system, a plurality of tasks to be performed by a user utilizing an information handling device;
determining, based on an analysis of attributes of each of the plurality of tasks and utilizing the task priority system, a priority of the plurality of tasks at least based in part on the information handling device being utilized by the user; and
providing, utilizing the task priority system, an output of the priority of the plurality of tasks to the user.

2. The method of claim 1, wherein the analysis comprises identifying an urgency of each of the plurality of tasks and wherein a priority of tasks having a higher urgency than other tasks is higher than the other tasks.

3. The method of claim 2, wherein the identifying an urgency is based upon historical data associated with a response time of the user with respect to a task having a similarity to each of the plurality of tasks.

4. The method of claim 1, wherein the analysis comprises identifying device attributes preferred by the user when performing each of the plurality of tasks and wherein a priority of a given of the plurality of tasks is based upon whether the information handling device has device attributes fulfilling the device attributes of the given of the plurality of tasks.

5. The method of claim 1, wherein the analysis comprises identifying application requirements for each of the plurality of tasks and wherein a priority of a given of the plurality of tasks is based upon whether the information handling device has applications fulfilling the application requirements of the given of the plurality of tasks.

6. The method of claim 1, wherein the analysis comprises identifying content of each of the plurality of tasks and a type for each of the plurality of tasks.

7. The method of claim 1, wherein, responsive to identifying the information handling device is unsuitable for performing a task of the plurality of tasks, recommending another information handling device for performing the task.

8. The method of claim 1, wherein a priority of tasks of the plurality of tasks that are suited from the information handling device is higher than a priority of other tasks of the plurality of tasks that are more suitable for another information handling.

9. The method of claim 1, wherein the priority of the plurality of tasks is changed upon detecting the user utilizing a different information handling device.

10. The method of claim 1, wherein the determining a priority is based upon user preferences related to tasks with respect to the information handling device and user attributes.

11. An information handling device, the information handling device comprising:
a processor;
a memory device that stores instructions that when executed by the processor, causes the information handling device to:
identify, utilizing a task priority system, a plurality of task to be performed by a user utilizing an information handling device;
determine, based on an analysis of attributes of each of the plurality of tasks and utilizing the task priority system, a priority of the plurality of tasks at least based in part on the information handling device being utilized by the user; and
provide, utilizing the task priority system, an output of the priority of the plurality of tasks of the user.

12. The information handling device of claim 11, wherein the analysis comprises identifying an urgency of ach of the plurality of tasks and wherein a priority of tasks having a higher urgency than other tasks is higher than the other tasks.

13. The information handling device of claim 12, wherein the identifying the urgency is based upon historical data associated with a response time of the user with respect to a task having a similarity to each of the plurality of tasks.

14. The information handling device of claim 11, wherein the analysis comprises identifying device attributes preferred by the user when performing each of the plurality of tasks and wherein a priority of a given of the plurality of tasks is based upon whether the information handling device has device attributes fulfilling the device attributes of the given of the plurality of tasks.

15. The information handling device of claim 11, wherein the analysis comprises identifying application requirements for each of the plurality of tasks and wherein a priority of a given of the plurality of task is based upon whether the information handling device has applications fulfilling the application requirements of the given of the plurality of tasks.

16. The information handling device of claim 11, wherein the analysis of comprises identifying content of each of the plurality of tasks and a type of for each of the plurality of tasks.

17. The information handling device of claim 11, wherein, responsive to identifying the information handling device is unsuitable for performing a task of the plurality of tasks, recommending another information handling device for performing the task.

18. The information handing device of claim 11, wherein a priority of tasks of the plurality of tasks that are suited from the information handling device is higher than priority of other tasks of the plurality of tasks that are more suitable for another information handling device.

19. The information handling device of claim 11, wherein to determine a priority is based upon user preferences related to tasks with respect to the information handling device and user attributes.

20. A product, the product comprising:
a computer-readable storage device that stores executable code that, when executed by the processor, causes the product to:
identify, utilizing a task priority system, a plurality of tasks to be performed by a user utilizing an information handling device;
determine, based on an analysis of attributes of each of the plurality of tasks and utilizing the task priority system, a priority of the plurality of tasks at least based in part on the information handling device being utilized by the user; and
provide, utilizing the task priority system, an output of the priority of the plurality of tasks to the user.
